(19) United States
(12) Patent Application Publication
(10) Pub. No.: US 2026/0292827 A1
(43) Pub. Date: Sep. 24, 2026

(54) SUB-PRB PUCCH

(71) Applicant: QUALCOMM Incorporated, San Diego, CA (US)

(72) Inventors: Mostafa KHOSHNEVISAN, San Diego, CA (US); Tao LUO, San Diego, CA (US); Xiaoxia ZHANG, San Diego, CA (US); Junyi LI, Greentown, PA (US)

(21) Appl. No.: 19/084,513

(22) Filed: Mar. 19, 2025

(51) Int. Cl. H04W 72/21; H04L 5/00; H04L 27/26

(52) U.S. Cl. CPC H04W 72/21; H04L 5/0007; H04L 27/26524

(57) ABSTRACT

Apparatus, methods, and computer program products for wireless communication are provided. An example method may include receiving, from a network entity, a physical uplink control channel (PUCCH) configuration that configures a quantity of orthogonal frequency-division multiplexing (OFDM) symbols for a PUCCH transmission. The example method may further include transmitting, to the network entity based on the quantity of OFDM symbols, the PUCCH transmission, where the PUCCH transmission occupies less than one full resource block (RB) per OFDM symbol.

### TECHNICAL FIELD

The present disclosure relates generally to communication systems, and more particularly, to wireless communication systems with physical uplink control channel (PUCCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network entity, a physical uplink control channel (PUCCH) configuration that configures a quantity of orthogonal frequency-division multiplexing (OFDM) symbols for a PUCCH transmission. Based at least in part on information stored in the at least one memory, the at least one processor, individually or in any combination, is configured to transmit, to the network entity based on the quantity of OFDM symbols, the PUCCH transmission, where the PUCCH transmission occupies less than one full resource block (RB) per OFDM symbol.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a user equipment (UE), a physical uplink control channel (PUCCH) configuration that configures a quantity of orthogonal frequency-division multiplexing (OFDM) symbols for a PUCCH transmission. Based at least in part on information stored in the at least one memory, the at least one processor, individually or in any combination, is configured to receive, from the UE based on the quantity of OFDM symbols, the PUCCH transmission, where the PUCCH transmission occupies less than one full resource block (RB) per OFDM symbol.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example of frequency hopping, in accordance with various aspects of the present disclosure.

FIG. 5A is a diagram illustrating an example of physical uplink control channel (PUCCH) transmission where PUCCH occupies less than one full resource block (RB) in the frequency domain, in accordance with various aspects of the present disclosure.

FIG. 5B is a diagram illustrating a second example of PUCCH transmission where PUCCH occupies less than one full RB in the frequency domain, in accordance with various aspects of the present disclosure.

FIG. 6 is a diagram illustrating a third example of PUCCH transmission where PUCCH occupies less than one full RB in the frequency domain, in accordance with various aspects of the present disclosure.

FIG. 7 is a diagram illustrating a fourth example of PUCCH transmission where PUCCH occupies less than one full RB in the frequency domain, in accordance with various aspects of the present disclosure.

FIG. 8 is a diagram illustrating a fifth example of PUCCH transmission where PUCCH occupies less than one full RB in the frequency domain, in accordance with various aspects of the present disclosure.

FIG. 9A is a diagram illustrating a sixth example of PUCCH transmission where PUCCH occupies less than one full RB in the frequency domain, in accordance with various aspects of the present disclosure.

FIG. 9B is a diagram illustrating a seventh example of PUCCH transmission where PUCCH occupies less than one full RB in the frequency domain, in accordance with various aspects of the present disclosure.

FIG. 9C is a diagram illustrating an eighth example of PUCCH transmission where PUCCH occupies less than one full RB in the frequency domain, in accordance with various aspects of the present disclosure.

FIG. 10 is a diagram illustrating example communications between a network entity and a UE, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity, in accordance with various aspects of the present disclosure.

FIG. 14 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein may enable physical uplink control channel (PUCCH) format that occupies less than one full resource block (RB) per orthogonal frequency-division multiplexing (OFDM) symbol where the quantity and location of OFDM symbols for the PUCCH transmission may be configurable. The quantity of REs for the PUCCH transmission or the location of the resource elements (REs) for the PUCCH transmission may also be configurable based on the uplink control information (UCI) payload. An RE offset for the PUCCH transmission may be payload dependent as well. The PUCCH format provided herein may allow resource efficient PUCCH transmissions that may also be highly flexible.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

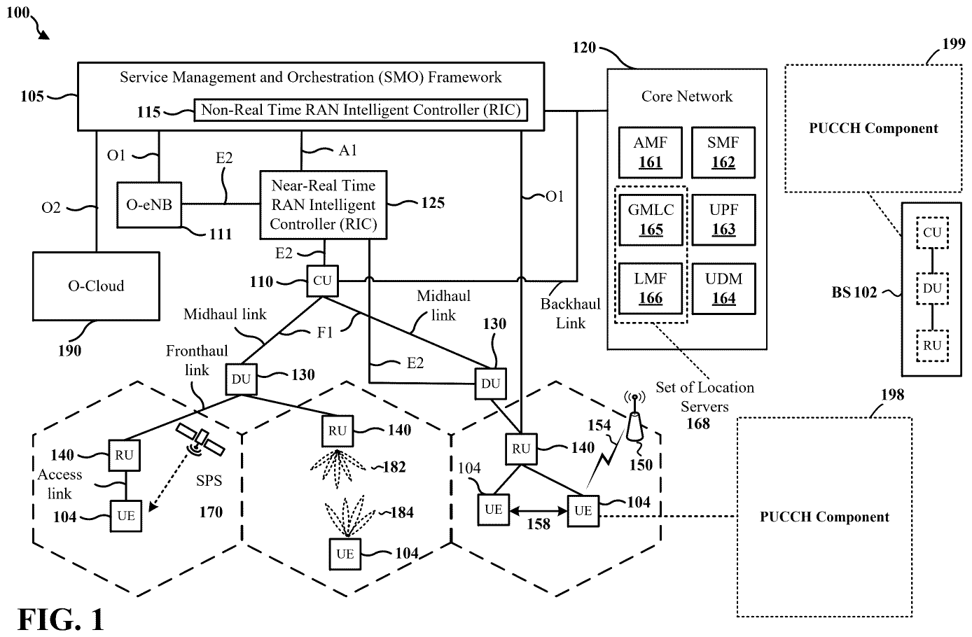

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a PUCCH component 198. In some aspects, the PUCCH component 198 may be configured to receive, from a network entity, a physical uplink control channel (PUCCH) configuration that configures a quantity of orthogonal frequency-division multiplexing (OFDM) symbols for a PUCCH transmission. In some aspects, the PUCCH component 198 may be further configured to transmit, to the network entity based on the quantity of OFDM symbols, the PUCCH transmission, where the PUCCH transmission occupies less than one full resource block (RB) per OFDM symbol.

In certain aspects, the base station 102 may include a PUCCH component 199. In some aspects, the PUCCH component 199 may be configured to transmit, for a user equipment (UE), a physical uplink control channel (PUCCH) configuration that configures a quantity of orthogonal frequency-division multiplexing (OFDM) symbols for a PUCCH transmission. In some aspects, the PUCCH component 199 may be further configured to receive, from the UE based on the quantity of OFDM symbols, the PUCCH transmission, where the PUCCH transmission occupies less than one full resource block (RB) per OFDM symbol.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

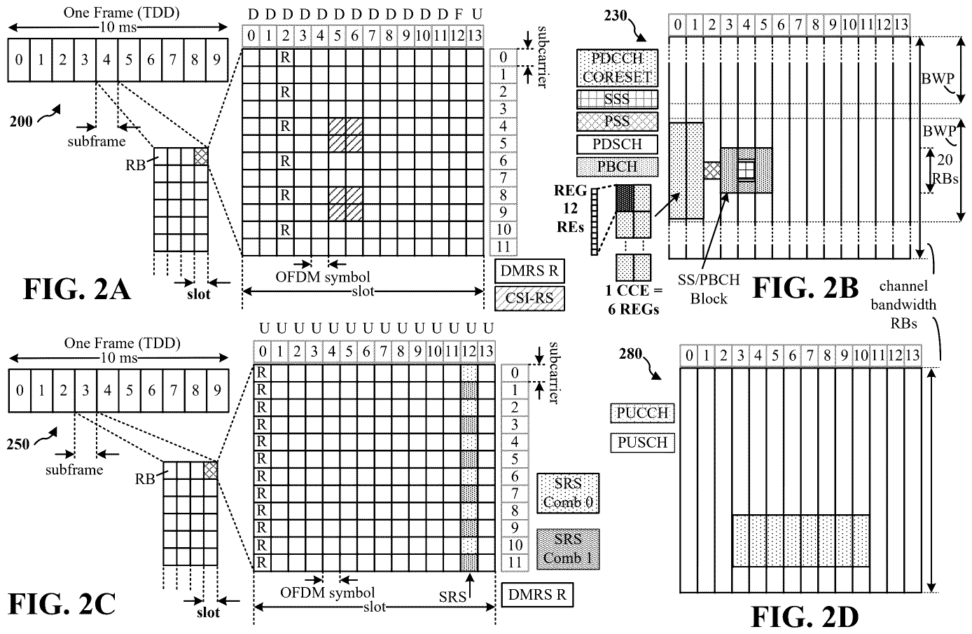

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

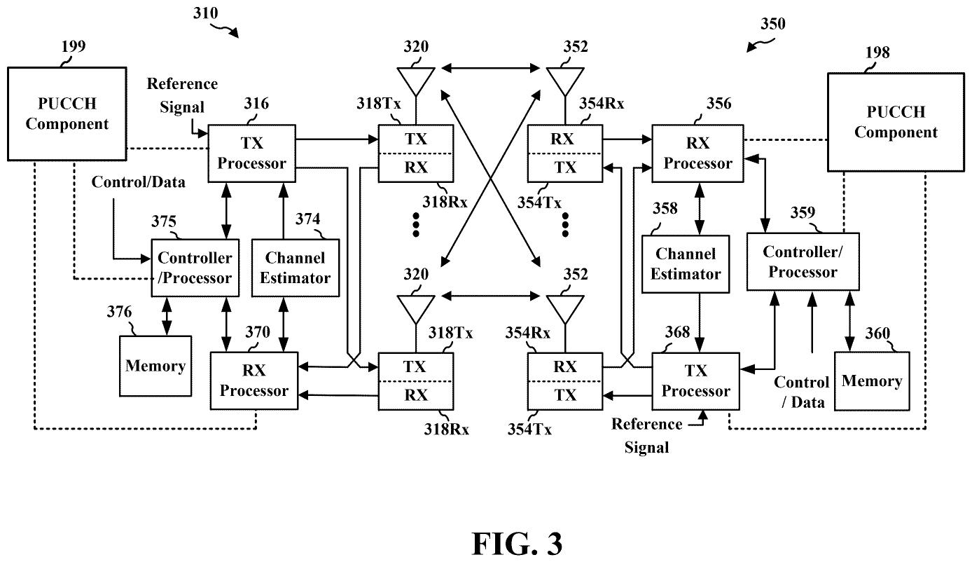

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with PUCCH component 198 of FIG. 1.

At least one of the TX processor 316, the RX processor 370, and the controller/processor 375 may be configured to perform aspects in connection with PUCCH component 199 of FIG. 1.

PUCCH transmissions may be used for transmitting uplink control information (UCI) payload from a UE to a network node. UCI may include hybrid automatic repeat request (HARQ) acknowledgment (ACK) or negative acknowledgment (NACK), scheduling requests, or channel state information (CSI). In some wireless communication systems, five different PUCCH formats may be supported: format 0, format 1, format 2, format 3, and format 4.

PUCCH format 0 may be used for short UCI transmissions involving one or two bits, such as HARQ feedback or scheduling requests. It uses a single RB and occupies one or two OFDM symbols. The waveform used for PUCCH format 0 is the cyclically shifted Golay (CGS) sequence, which may be generated by applying a cyclic shift to a base sequence. The cyclic shift value may be determined by the PUCCH resource index, slot number, and cyclic shift hopping configuration.

Compared to PUCCH format 0, PUCCH format 1 is also used for small UCI payloads (up to two bits) but extends over four to fourteen OFDM symbols while still using one RB. PUCCH format 1 also uses CGS sequence. PUCCH format 1 supports time-domain orthogonal cover codes (TD-OCC) for increased reliability and flexibility. PUCCH format 2 may be used for longer duration feedback scenarios.

PUCCH format 2 may be used for scenarios that would use more than two UCI bits. PUCCH format 2 is configurable to use one or more RBs and spans one or two OFDM symbols. The waveform used in PUCCH format 2 is OFDM. PUCCH format 2 may be used for scenarios with short burst transmissions that may have more bits than PUCCH formats 0 or 1.

PUCCH format 3 may be used for larger UCI payloads, such as CSI reports or multiple HARQ feedback bits. PUCCH format 3 may span four to fourteen OFDM symbols and may use one or more configurable RBs. PUCCH format 3 is based on discrete Fourier transform spread OFDM (DFT-S-OFDM) waveform. PUCCH may not support multiplexing, and may be dedicated to a single UCI transmission per UE.

PUCCH format 4 is also for larger UCI payloads and uses a structure similar to format 3, with four to fourteen OFDM symbols and one RB. PUCCH format 4 uses the DFT-S-OFDM waveform. Different from PUCCH format 3, PUCCH format 4 supports multiplexing capability, which allows multiple UEs to simultaneously transmit within the same set of time-frequency resources.

In some wireless communication systems, frequency hopping within one PUCCH resource may be supported. Frequency hopping within one PUCCH resource is a technique used that may enhance the reliability and robustness of uplink control signaling by varying the frequency components of the transmitted signal within a single PUCCH resource. A PUCCH resource may be a specific allocation of time and frequency used by the UE to transmit UCI. By employing frequency hopping within this resource, the UE may change the subcarriers it uses to transmit its control information over time, while still staying within the allocated PUCCH resource block. Frequency hopping may be employed in two different ways, intra-slot frequency hopping and inter-slot frequency hopping. In intra-slot frequency hopping, the UE changes the subcarriers it uses within a single slot. For example, if a PUCCH resource spans multiple OFDM symbols within one slot, the UE may switch to different subcarriers for each OFDM symbol or group of symbols. In inter-slot frequency hopping, frequency hopping occurs between slots, meaning the UE uses different sets of subcarriers in consecutive slots while transmitting the same UCI.

Frequency hopping within one PUCCH resource may be configured and controlled by a network node. For example, higher-layer parameter intraSlotFrequencyHopping is enabled, intra-slot frequency hopping may be used. As an example, for PUCCH format 0,2 (short) with two symbols, a first symbol of the PUCCH may be on the first frequency hop and a second symbol of the PUCCH may be on a second frequency hop.

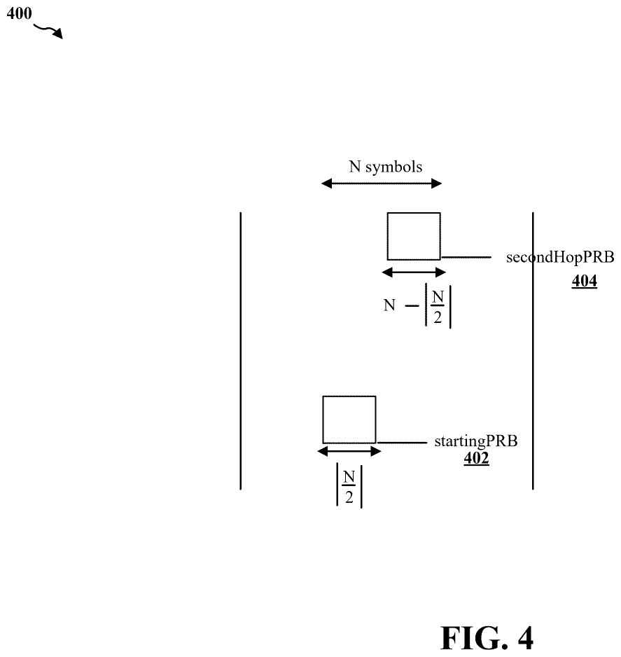

FIG. 4 is a diagram 400 illustrating an example of frequency hopping, in accordance with various aspects of the present disclosure. As illustrated in FIG. 4, there may be a first hop 402 on a starting PRB and a second hop 404 on a second hop PRB.

In some wireless communication systems, all PUCCH formats occupy at least one RB, which is twelve REs. However, when UL coverage is limited, sub-PRB PUCCH, which is a PUCCH transmission that occupies less than one full RB may be beneficial. Power boost (per OFDM symbol) may be done so that the total energy may not be reduced when number of REs in frequency is reduced. A smaller number of resources are occupied without impacting total energy for the UE, which may allow more resources to be multiplexed for other UEs (more resource efficient). A lower peak to average power ratio (PAPR) may allow increase of transmit power of the power amplifier which may result in coverage boost. Aspects provided herein may enable PUCCH format that occupies less than one full RB per OFDM symbol where the quantity and location of OFDM symbols for the PUCCH transmission may be configurable. The quantity of REs for the PUCCH transmission or the location of the REs for the PUCCH transmission may also be configurable based on the UCI payload. An RE offset for the PUCCH transmission may be payload dependent as well. The PUCCH format provided herein may allow resource efficient PUCCH transmissions that may also be highly flexible.

In some aspects, a PUCCH format may be introduced such that the resources in frequency domain occupy less than one full RB per OFDM symbol, where the number of OFDM symbols (denoted by N) is configured to the UE (e.g., in a PUCCH configuration). In some aspects, in the frequency domain, the number of consecutive REs may be 6, 4, 3, 2, or 1 per OFDM symbol. In some aspects, the number of REs (denoted by M) may be configured per PUCCH resource. In some aspects, quantity or location(s) of the set of M REs in an RB may be also configured per PUCCH resource. For example, if M=6, first half or second half of an RB can be configured for a given PUCCH resource; or if M=1, a particular one (e.g., any one) of the 12 REs of an RB may be configured for a given PUCCH resource. In some aspects, the configuration may be in the form of an RE offset within an RB. The RE offset may specify a shift or offset in the position of an RE within an RB compared to a reference location, which would be effectively an indication of where the RE for the UCI is at and indicates how the UCI is distributed across the available REs within the PUCCH resource. In some aspects, the RB (and second hop RB in case of frequency hopping) may be configured per PUCCH resource. In some aspects, in the time domain, the PUCCH format where the resources in the frequency domain occupy less than one full RB per OFDM symbol may occupy: (1) 1-2 OFDM symbols in time, (2) 4-14 OFDM symbols in time, or (3) a flexible number of OFDM symbols (1-14). In some aspects, the starting symbol and the number of symbols (N) may be configured per PUCCH resource.

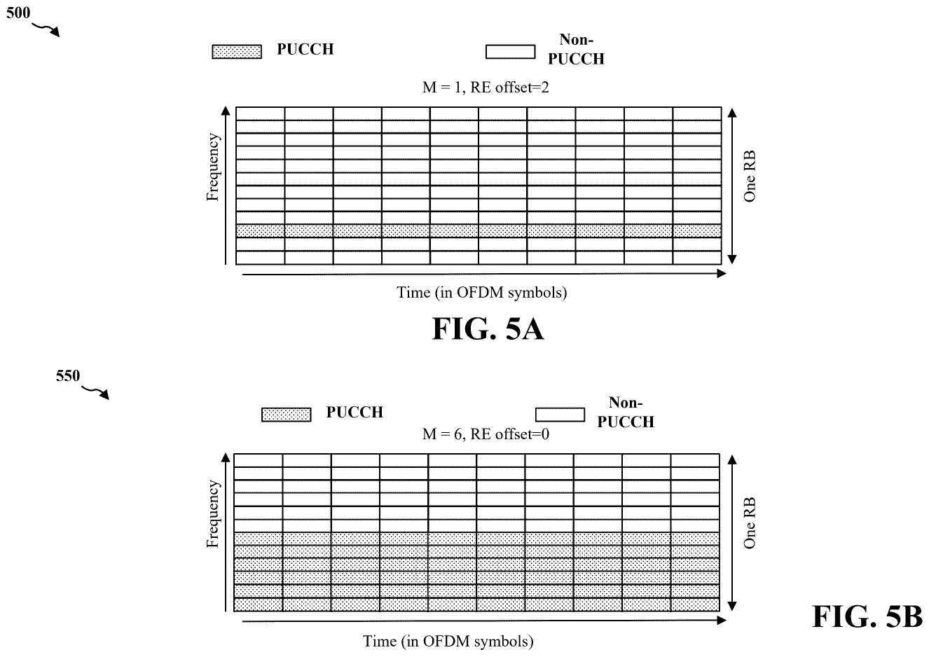

FIG. 5A is a diagram 500 illustrating an example of PUCCH transmission where PUCCH occupies less than one full RB in the frequency domain, in accordance with various aspects of the present disclosure. As illustrated in FIG. 5A, RE offset may be two where the PUCCH REs has a two RE distance from a bottom of the RB and M may be one where there may be one RE per RB for each OFDM symbol.

FIG. 5B is a diagram 550 illustrating a second example of PUCCH transmission where PUCCH occupies less than one full RB in the frequency domain, in accordance with various aspects of the present disclosure. As illustrated in FIG. 5B, RE offset may be zero where the PUCCH REs has no RE distance from a bottom of the RB and M may be six where there may be six REs per RB for each OFDM symbol.

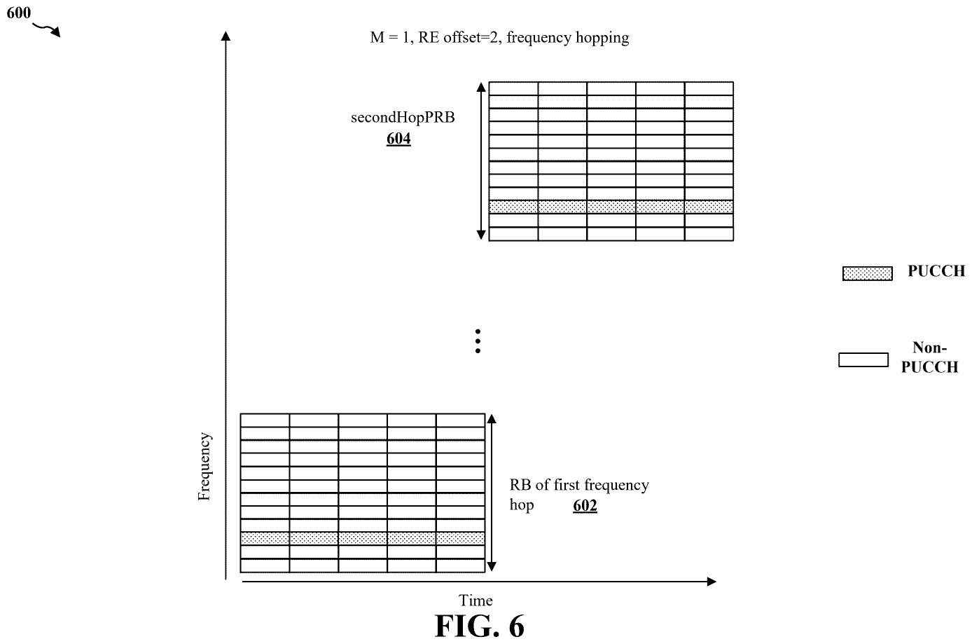

FIG. 6 is a diagram 600 illustrating a third example of PUCCH transmission where PUCCH occupies less than one full RB in the frequency domain, in accordance with various aspects of the present disclosure. As illustrated in FIG. 6, there may be a first hop 602 on a first PRB and a second hop 604 on a second PRB, the RB offset and M may be the same across different hops.

In some aspects, the quantity of UCI bits that may be transmitted by the PUCCH format where the resources in the frequency domain occupy less than one full RB per OFDM symbol may depend on how the UCI payload is being transmitted. In some aspects, the quantity of UCI bits may be smaller than a maximum UCI bit size X (e.g., one, two, or larger), where X may be a fixed and specified value, may be configurable via radio resource control (RRC), or may be dependent on a total quantity of REs in frequency-time resources, i.e., M·N. In some aspects, to transmit the UCI payload, the UCI payload may have a payload size of k bits and may be mapped to a sequence (from a total of 2^{k} sequences), and the sequence may be transmitted in the M·N REs for the PUCCH transmission. In some aspects, the sequence may be determined based on row/column index n of size-N discrete Fourier transform (DFT) matrix (0≤n≤N−1) in the time domain (e.g., such as in scenarios with M smaller than a threshold). In some aspects, the sequence may be determined based on a cyclic shift value m_{CS} (0≤m_{CS}≤M−1) in the frequency domain, where M≥2^{k}. In some aspects, the sequence is determined based on a pair of cyclic shift and row/column index of DFT matrix (m_{CS},n) such that UE transmits k=k₁+k₂ bits UCI [a₁, . . . , aₖ] by mapping k₁ bits to cyclic shift m_{CS} and k₂ bits to row/column index n, where M≥2^{k}^{₁} and N≥2^{k}^{₂}. In some aspects, a PUCCH configuration may configure the different methods for determination of the sequence to be associated with different scenarios (e.g., depending on the type of the UCI, the size of M, N, or k, or the like), and the UE may use one of the different configured methods based on the scenario.

In some aspects, an RE offset may be determined based on UCI payload (e.g., different payloads are mapped to different set of REs in frequency), which may be referred to as “payload dependent RE offset”. In some aspects, the same sequence may be sent irrespective of the UCI payload. Such payload dependent RE offset may be in addition to the resource-specific RE offset. For example, the final RE offset within an RB may be based on both the payload dependent RE offset and the resource-specific RE offset based on a mathematical operation, such as (resource-specific RE offset+payload dependent RE offset) mod 12. In some aspects, the mapping between possible payloads and RE offsets may be fixed (e.g., equal-distance) or may be RRC configured for the UE. For example, for k bits UCI, 2^{k} RE offsets may be used to convey the payload. As one particular example, for k=1 or 2 bits, payload dependent RE offsets may be equal-distance, e.g., {0, 6} for 1 bit or {0,3,6,9} for 2 bits. For k=3 bits, 8 out of the 12 RE offsets may be mapped to the 8 possible payloads, e.g., {0, 1, . . . , 7}. For k≥4 bits, because more than 12 RE offsets may be used, the RE offset may be no longer defined as “within an RB”, which means that depending on the payload, the RB that contains the set of REs may also change.

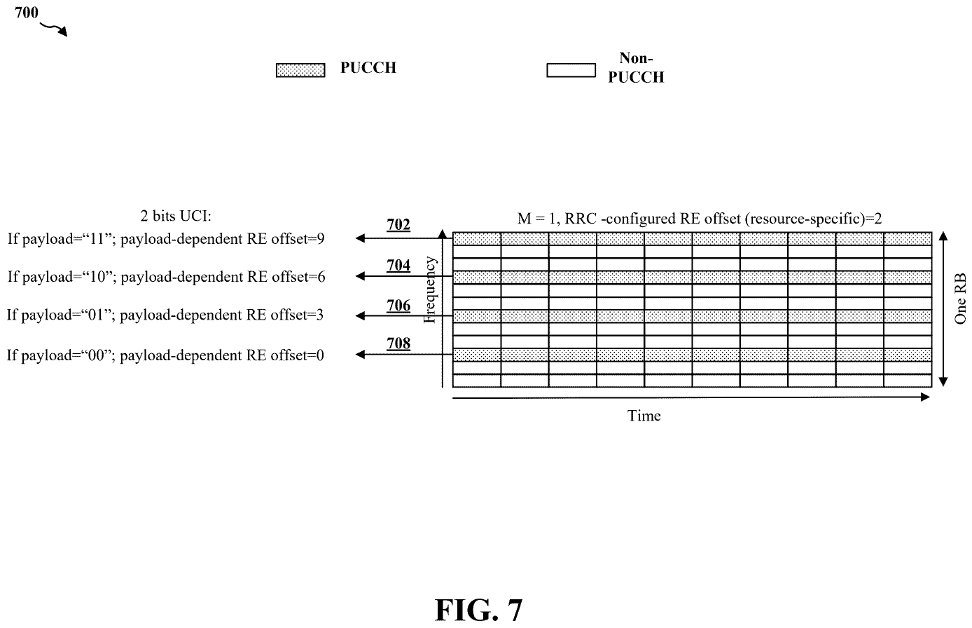

FIG. 7 is a diagram 700 illustrating a fourth example of PUCCH transmission where PUCCH occupies less than one full RB in the frequency domain, in accordance with various aspects of the present disclosure. As illustrated in FIG. 7, based on the payload, the RE offset may be different. For example, at 702, if payload=“11”; payload-dependent RE offset=9. At 704, if payload=“10”; payload-dependent RE offset=6. At 706, if payload=“01”; payload-dependent RE offset=3. at 708, if payload=“00”; payload-dependent RE offset=0.

In some aspects, UCI payload determines the number of M REs in the RB (in addition to the set of REs/RE offset). For example, there may be unequal error protection, where larger M is used in case of the UCI payload being NACK compared to ACK (when UCI carries HARQ feedback). As another example, there may be NACK without ACK or ACK without NACK where M=0 in case of ACK but M>0 in case of NACK (UE transmits for NACK without transmitting for ACK) or M=0 in case of NACK but M>0 in case of ACK (UE transmits only for ACK without transmitting for NACK).

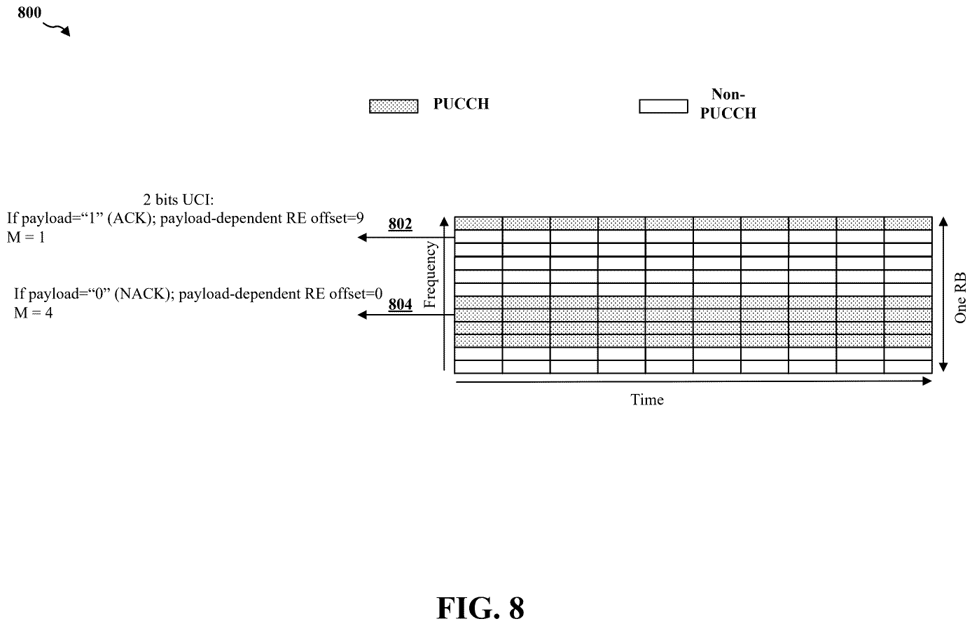

FIG. 8 is a diagram 800 illustrating a fifth example of PUCCH transmission where PUCCH occupies less than one full RB in the frequency domain, in accordance with various aspects of the present disclosure. As illustrated in FIG. 8, at 802, if payload=“1” (ACK); payload-dependent RE offset=9; payload-dependent M=1. At 804, if payload=“0” (NACK); payload-dependent RE offset=0, payload-dependent M=4.

In some aspects, there may be a combination of mapping to a sequence and payload dependent RE offset where a k bits UCI are divided into k′+k″ bits, and k′ bits are sent based on the determined sequence, and k″ bits are sent based on payload dependent RE offset. In some aspects, the PUCCH transmission may be based on encoding the UCI payload (using repetition/simplex/reed-muller/polar), where the encoded bits are mapped to a subset of REs and DMRS sequence is transmitted in another subset of REs.

In some aspects, location(s) or quantity of the set of M REs in an RB may be different in different OFDM symbols of the PUCCH resource. For example, different RE offsets in different OFDM symbols may be configured for the PUCCH resource. The location(s) or quantity of the set of M REs in an RB may be PUCCH resource-specific (not a function of payload) or may be payload-dependent to convey the payload (e.g., convey ACK, NACK, or the like). If the location(s) or quantity of the set of M REs in an RB is payload-dependent, the number of OFDM symbols may be also different for different payloads, e.g., M=0 for a subset of OFDM symbols in case of one more specific payload.

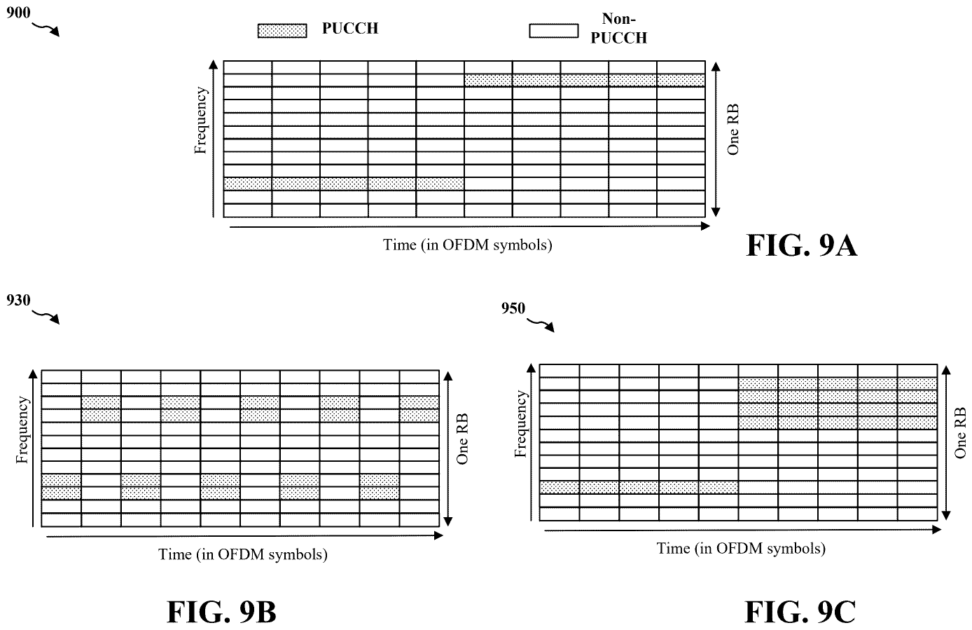

FIG. 9A is a diagram 900 illustrating a sixth example of PUCCH transmission where PUCCH occupies less than one full RB in the frequency domain, in accordance with various aspects of the present disclosure. As illustrated in FIG. 9A, locations of RE(s) (e.g., RE offset) may be different for different OFDM symbols, where the quantity of REs per RB for different OFDM symbols stays the same at one.

FIG. 9B is a diagram 930 illustrating a seventh example of PUCCH transmission where PUCCH occupies less than one full RB in the frequency domain, in accordance with various aspects of the present disclosure. As illustrated in FIG. 9B, locations of RE(s) (e.g., RE offset) may be different for different OFDM symbols, where the quantity of REs per RB for different OFDM symbols stays the same at two.

FIG. 9C is a diagram 950 illustrating an eighth example of PUCCH transmission where PUCCH occupies less than one full RB in the frequency domain, in accordance with various aspects of the present disclosure. As illustrated in FIG. 9A, locations of RE(s) (e.g., RE offset) may be different for different OFDM symbols, where the quantity of REs per RB for different OFDM symbols may be different as well.

In some aspects, there may be some OFDM symbols that have no PUCCH REs in between those OFDM symbols that have PUCCH REs. This may be a property of PUCCH resource (not a function of payload) based on configuration, or may be payload-dependent.

In some aspects, the PUCCH format where the PUCCH occupies less than one full RB in the frequency domain may be used in connection with PUCCH repetitions (in different slots), intra-slot frequency hopping, or inter-slot/inter-repetition frequency hopping. In some aspects, for multi-slot PUCCH, the codework/sequence can be mapped jointly over multiple slots in the sub-PRB (in the set of M REs in the RB across symbols of multiple slots). In some aspects, the sequence used in time domain may be across multiple symbols in one/multiple slots and may be divided into multiple groups, i.e., N=G·S which may be divided into G groups of S symbols each, where sequence is separately mapped to each group (which may be useful for high Doppler case where channel changes quickly across time, and the cyclic shift used across different group of symbols may also be different (inter-group cyclic shift hopping)). In some aspects, the PUCCH format where the PUCCH occupies less than one full RB in the frequency domain may be used for one or more particular use cases, such as a particular uplink control information (UCI) type (e.g., for HARQ ACK or scheduling request, but not used for CSI), a particular quantity of UCI bits (e.g., for less than a threshold amount (e.g., one or two bits), but not for more than the threshold amount of bits (e.g., no more than two bits)), or a particular quantity of OFDM symbols (e.g., greater than a threshold amount (e.g., four or eight) symbols, but not for less than the threshold amount of symbols). In some aspects, the PUCCH format where the PUCCH occupies less than one full RB in the frequency domain may be configured per PUCCH resource (for PUCCH resources that satisfy the certain conditions such as quantity of UCI bits, quantity of OFDM symbols, or UCI type) via RRC or MAC-CE. In some aspects, the UE may indicate support for the PUCCH format where the PUCCH occupies less than one full RB in the frequency domain in a capability signaling.

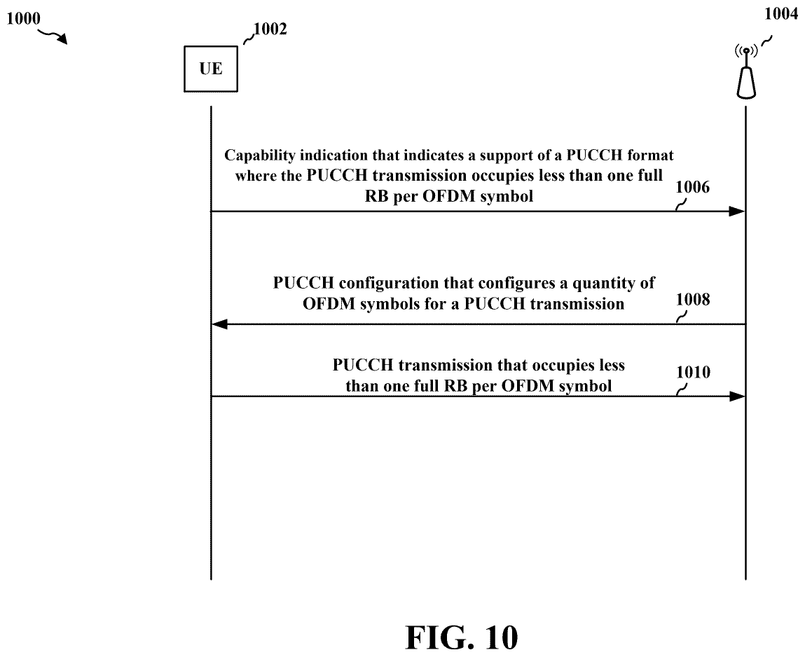

FIG. 10 is a diagram 1000 illustrating example communications between a network entity 1004 and a UE 1002, in accordance with various aspects of the present disclosure.

As illustrated in FIG. 10, the network entity 1004 may receive, from the UE 1002, a capability indication 1006 that indicates a support of a PUCCH format where the PUCCH transmission occupies less than one full RB per OFDM symbol, as described herein in connection with FIG. 5A to FIG. 9C. The network entity 1004 may configure, for the UE 1002, a PUCCH configuration 1008 that configures a quantity of OFDM symbols (N) for a PUCCH transmission 1010. In some aspects, the UE 1002 may transmit the PUCCH transmission 1010 based on the quantity of OFDM symbols, where the PUCCH transmission occupies less than one full RB per OFDM symbol.

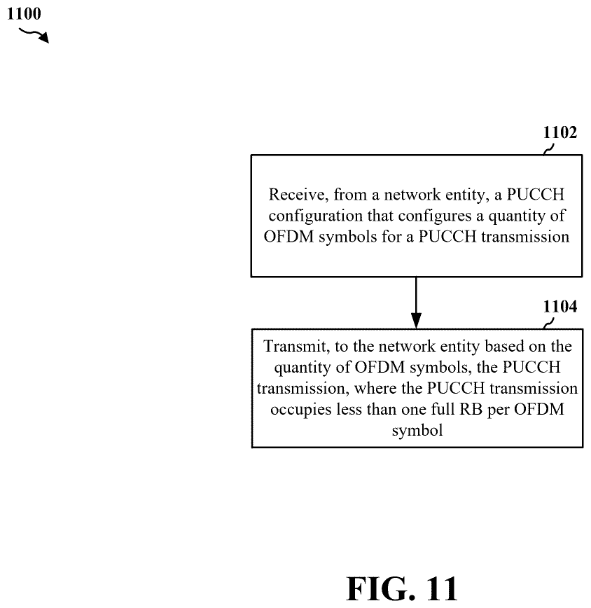

FIG. 11 is a flowchart 1100 of a method of wireless communication. The method may be performed by a UE (e.g., the UE 104, the UE 1002; the apparatus 1304). The method may enable PUCCH format that occupies less than one full RB per OFDM symbol where the quantity and location of OFDM symbols for the PUCCH transmission may be configurable. The quantity of REs for the PUCCH transmission or the location of the REs for the PUCCH transmission may also be configurable based on the UCI payload. An RE offset for the PUCCH transmission may be payload dependent as well. The PUCCH format provided herein may allow resource efficient PUCCH transmissions that may also be highly flexible.

At 1102, the UE may receive, from a network entity, a PUCCH configuration that configures a quantity of OFDM symbols for a PUCCH transmission. For example, the UE 1002 may receive, from a network entity 1004, a PUCCH configuration 1008 that configures a quantity of OFDM symbols for a PUCCH transmission. In some aspects, 1102 may be performed by PUCCH component 198.

At 1104, the UE may transmit, to the network entity based on the quantity of OFDM symbols, the PUCCH transmission, where the PUCCH transmission occupies less than one full RB per OFDM symbol. For example, the UE 1002 may transmit, to the network entity 1004 based on the quantity of OFDM symbols, the PUCCH transmission 1010, where the PUCCH transmission 1010 occupies less than one full RB per OFDM symbol. In some aspects, 1104 may be performed by PUCCH component 198.

In some aspects, the PUCCH configuration further configures a quantity of a set of REs per a PUCCH resource associated with the PUCCH transmission or a set of locations of the set of REs. In some aspects, a UCI payload associated with the PUCCH transmission has a payload size smaller than a maximum payload size, or where the maximum payload size is based on the quantity of OFDM symbols and the quantity of the set of REs, or based on a RRC configuration. In some aspects, the UCI payload is mapped to a sequence, where the sequence is based on a DFT matrix that has a size equal to the quantity of OFDM symbols. In some aspects, the UCI payload is mapped to a sequence, where the sequence is based on a cyclic shift that has a cyclic shift value smaller than a maximum cyclic shift value, and where the maximum cyclic shift value is based on the quantity of the set of REs. In some aspects, the UCI payload is mapped to a sequence, where the sequence is based on a DFT matrix that has a size equal to the quantity of OFDM symbols, and where the sequence is further based on a cyclic shift that has a cyclic shift value smaller than a maximum cyclic shift value, and where the maximum cyclic shift value is based on the quantity of the set of REs. In some aspects, a RE offset associated with the UCI payload is based on the UCI payload. In some aspects, the quantity of the set of REs is based on the UCI payload, and where the RE offset is based on the UCI payload. In some aspects, the UCI payload is ACK, where the quantity of the set of REs is based on a first quantity associated with the ACK, and where the RE offset is based on a first offset associated with the ACK. In some aspects, the UCI payload is NACK, where the quantity of the set of REs is based on a first quantity associated with the NACK, and where the RE offset is based on a first offset associated with the NACK. In some aspects, the UCI payload is mapped to a sequence, and where the sequence is jointly mapped over multiple slots associated with the PUCCH transmission. In some aspects, the UCI payload is mapped to a sequence, and where the sequence is divided into multiple groups in a time domain and separately mapped to each group of the multiple groups. In some aspects, each OFDM symbol of a set of OFDM symbols associated with the PUCCH transmission is associated with a respective set of REs with a respective set of locations. In some aspects, each OFDM symbol of a set of OFDM symbols associated with the PUCCH transmission is associated with a respective quantity of REs configured by the PUCCH configuration.

In some aspects, the UE (e.g., 1002) may also transmit, to the network entity, a capability indication (e.g., 1006) that indicates a support of a PUCCH format where the PUCCH transmission occupies less than one full RB per OFDM symbol. In some aspects, the PUCCH format is applicable based on a UCI type associated with the PUCCH transmission, a UCI payload size associated with the PUCCH transmission, or the quantity of OFDM symbols.

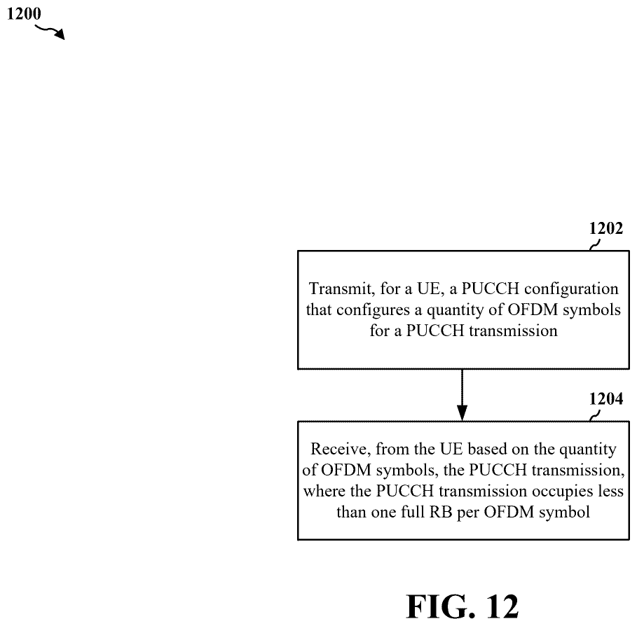

FIG. 12 is a flowchart 1200 of a method of wireless communication. The method may be performed by a network entity (e.g., the base station 102, the network entity 1004, the network entity 1302, the network entity 1402). The method may enable PUCCH format that occupies less than one full RB per OFDM symbol where the quantity and location of OFDM symbols for the PUCCH transmission may be configurable. The quantity of REs for the PUCCH transmission or the location of the REs for the PUCCH transmission may also be configurable based on the UCI payload. An RE offset for the PUCCH transmission may be payload dependent as well. The PUCCH format provided herein may allow resource efficient PUCCH transmissions that may also be highly flexible.

At 1202, the network entity may transmit, for a UE, a PUCCH configuration that configures a quantity of OFDM symbols for a PUCCH transmission. For example, the network entity 1004 may transmit, for a UE 1002, a PUCCH configuration that configures a quantity of OFDM symbols for a PUCCH transmission. In some aspects, 1202 may be performed by PUCCH component 199.

At 1204, the network entity may receive, from the UE based on the quantity of OFDM symbols, the PUCCH transmission, where the PUCCH transmission occupies less than one full RB per OFDM symbol. For example, the network entity 1004 may receive, from the UE 1002 based on the quantity of OFDM symbols, the PUCCH transmission 1010, where the PUCCH transmission occupies less than one full RB per OFDM symbol. In some aspects, 1204 may be performed by PUCCH component 199.

In some aspects, the PUCCH configuration further configures a quantity of a set of REs per a PUCCH resource associated with the PUCCH transmission or a set of locations of the set of REs. In some aspects, a UCI payload associated with the PUCCH transmission has a payload size smaller than a maximum payload size, or where the maximum payload size is based on the quantity of OFDM symbols and the quantity of the set of REs, or based on a RRC configuration. In some aspects, the UCI payload is mapped to a sequence, where the sequence is based on a DFT matrix that has a size equal to the quantity of OFDM symbols. In some aspects, the UCI payload is mapped to a sequence, where the sequence is based on a cyclic shift that has a cyclic shift value smaller than a maximum cyclic shift value, and where the maximum cyclic shift value is based on the quantity of the set of REs. In some aspects, the UCI payload is mapped to a sequence, where the sequence is based on a DFT matrix that has a size equal to the quantity of OFDM symbols, and where the sequence is further based on a cyclic shift that has a cyclic shift value smaller than a maximum cyclic shift value, and where the maximum cyclic shift value is based on the quantity of the set of REs. In some aspects, a RE offset associated with the UCI payload is based on the UCI payload. In some aspects, the quantity of the set of REs is based on the UCI payload, and where the RE offset is based on the UCI payload. In some aspects, the UCI payload is ACK, where the quantity of the set of REs is based on a first quantity associated with the ACK, and where the RE offset is based on a first offset associated with the ACK. In some aspects, the UCI payload is NACK, where the quantity of the set of REs is based on a first quantity associated with the NACK, and where the RE offset is based on a first offset associated with the NACK. In some aspects, the UCI payload is mapped to a sequence, and where the sequence is jointly mapped over multiple slots associated with the PUCCH transmission. In some aspects, the UCI payload is mapped to a sequence, and where the sequence is divided into multiple groups in a time domain and separately mapped to each group of the multiple groups. In some aspects, each OFDM symbol of a set of OFDM symbols associated with the PUCCH transmission is associated with a respective set of REs with a respective set of locations. In some aspects, each OFDM symbol of a set of OFDM symbols associated with the PUCCH transmission is associated with a respective quantity of REs configured by the PUCCH configuration.

In some aspects, the network entity (e.g., 10024 may also receive, from the UE, a capability indication (e.g., 1006) that indicates a support of a PUCCH format where the PUCCH transmission occupies less than one full RB per OFDM symbol. In some aspects, the PUCCH format is applicable based on a UCI type associated with the PUCCH transmission, a UCI payload size associated with the PUCCH transmission, or the quantity of OFDM symbols.

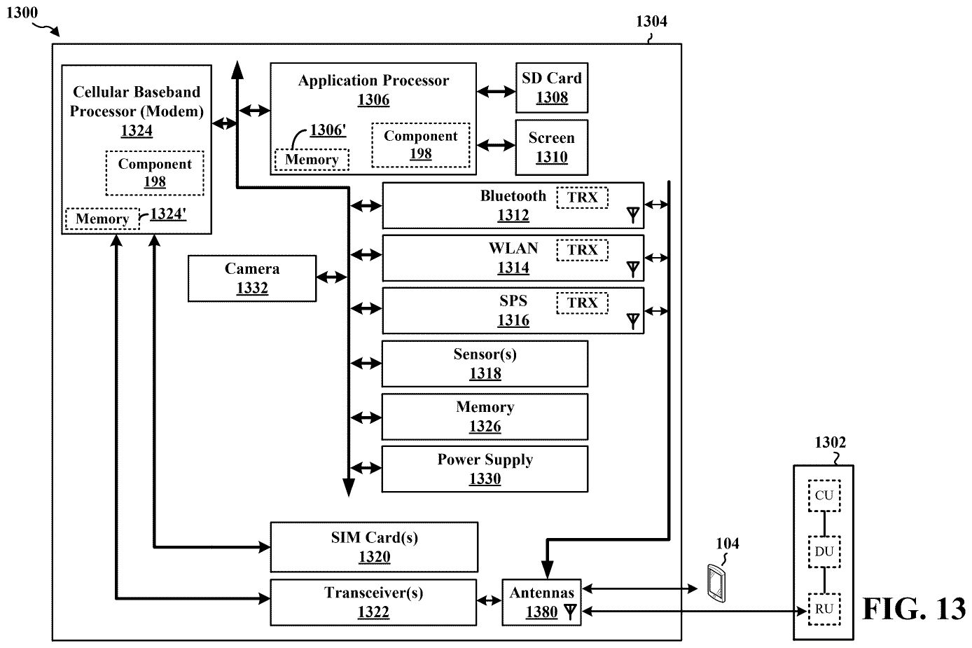

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the PUCCH component 198 may be configured to receive, from a network entity, a physical uplink control channel (PUCCH) configuration that configures a quantity of orthogonal frequency-division multiplexing (OFDM) symbols for a PUCCH transmission. In some aspects, the PUCCH component 198 may be further configured to transmit, to the network entity based on the quantity of OFDM symbols, the PUCCH transmission, where the PUCCH transmission occupies less than one full resource block (RB) per OFDM symbol. The PUCCH component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, from a network entity, a physical uplink control channel (PUCCH) configuration that configures a quantity of orthogonal frequency-division multiplexing (OFDM) symbols for a PUCCH transmission. In some aspects, the apparatus 1304 may include means for transmitting, to the network entity based on the quantity of OFDM symbols, the PUCCH transmission, where the PUCCH transmission occupies less than one full resource block (RB) per OFDM symbol. In some aspects, the apparatus 1304 may include means for transmitting, to the network entity, a capability indication that indicates a support of a PUCCH format where the PUCCH transmission occupies less than one full RB per OFDM symbol. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

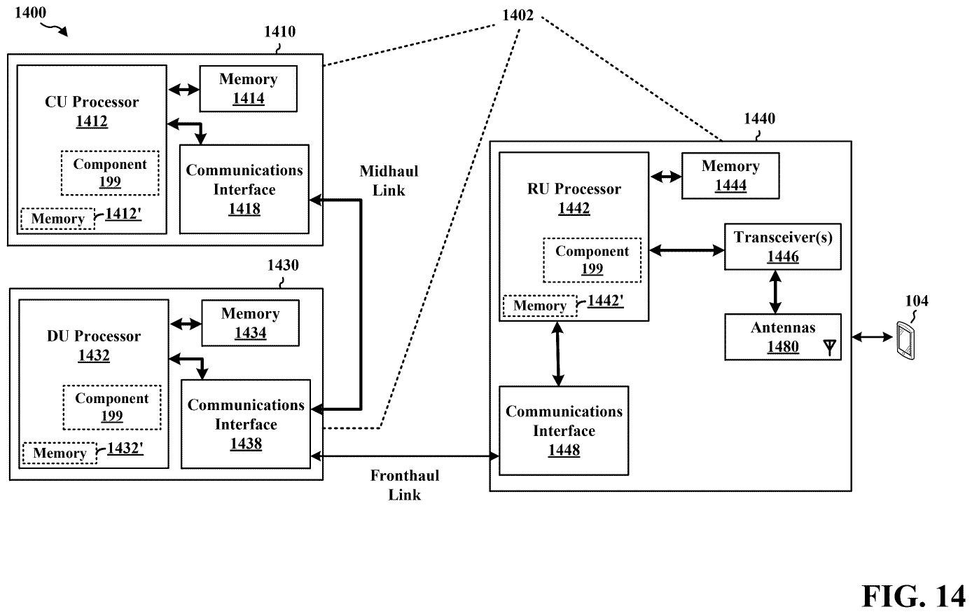

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the PUCCH component 199 may be configured to transmit, for a user equipment (UE), a physical uplink control channel (PUCCH) configuration that configures a quantity of orthogonal frequency-division multiplexing (OFDM) symbols for a PUCCH transmission. In some aspects, the PUCCH component 199 may be further configured to receive, from the UE based on the quantity of OFDM symbols, the PUCCH transmission, where the PUCCH transmission occupies less than one full resource block (RB) per OFDM symbol. The PUCCH component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for transmitting, for a user equipment (UE), a physical uplink control channel (PUCCH) configuration that configures a quantity of orthogonal frequency-division multiplexing (OFDM) symbols for a PUCCH transmission. In some aspects, the network entity 1402 may include means for receiving, from the UE based on the quantity of OFDM symbols, the PUCCH transmission, where the PUCCH transmission occupies less than one full resource block (RB) per OFDM symbol. In some aspects, the network entity 1402 may include means for receiving, from the UE, a capability indication that indicates a support of a PUCCH format where the PUCCH transmission occupies less than one full RB per OFDM symbol. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is an apparatus for wireless communication at a user equipment (UE), including: at least one memory; and at least one processor coupled to the at least one memory, and based at least in part on information stored in the at least one memory, the at least one processor is configured to: receive, from a network entity, a PUCCH configuration that configures a quantity of OFDM symbols for a PUCCH transmission; and transmit, to the network entity based on the quantity of OFDM symbols, the PUCCH transmission, where the PUCCH transmission occupies less than one full RB per OFDM symbol.
Aspect 2 is the apparatus of aspect 1, where the PUCCH configuration further configures a quantity of a set of REs per a PUCCH resource associated with the PUCCH transmission or a set of locations of the set of REs.
Aspect 3 is the apparatus of aspect 2, where a UCI payload associated with the PUCCH transmission has a payload size smaller than a maximum payload size, or where the maximum payload size is based on the quantity of OFDM symbols and the quantity of the set of REs, or based on a RRC configuration.
Aspect 4 is the apparatus of aspect 3, where the UCI payload is mapped to a sequence, where the sequence is based on a DFT matrix that has a size equal to the quantity of OFDM symbols.
Aspect 5 is the apparatus of aspect 3, where the UCI payload is mapped to a sequence, where the sequence is based on a cyclic shift that has a cyclic shift value smaller than a maximum cyclic shift value, and where the maximum cyclic shift value is based on the quantity of the set of REs.
Aspect 6 is the apparatus of aspect 3, where the UCI payload is mapped to a sequence, where the sequence is based on a DFT matrix that has a size equal to the quantity of OFDM symbols, and where the sequence is further based on a cyclic shift that has a cyclic shift value smaller than a maximum cyclic shift value, and where the maximum cyclic shift value is based on the quantity of the set of REs.
Aspect 7 is the apparatus of any of aspects 3-6, where a RE offset associated with the UCI payload is based on the UCI payload.
Aspect 8 is the apparatus of aspect 7, where the quantity of the set of REs is based on the UCI payload, and where the RE offset is based on the UCI payload.
Aspect 9 is the apparatus of aspect 8, where the UCI payload is acknowledgment (ACK), where the quantity of the set of REs is based on a first quantity associated with the ACK, and where the RE offset is based on a first offset associated with the ACK.
Aspect 10 is the apparatus of aspect 8, where the UCI payload is NACK, where the quantity of the set of REs is based on a first quantity associated with the NACK, and where the RE offset is based on a first offset associated with the NACK.
Aspect 11 is the apparatus of any of aspects 3-10, where the UCI payload is mapped to a sequence, and where the sequence is jointly mapped over multiple slots associated with the PUCCH transmission.
Aspect 12 is the apparatus of any of aspects 3-10, where the UCI payload is mapped to a sequence, and where the sequence is divided into multiple groups in a time domain and separately mapped to each group of the multiple groups.
Aspect 13 is the apparatus of any of aspects 1-12, where each OFDM symbol of a set of OFDM symbols associated with the PUCCH transmission is associated with a respective set of REs with a respective set of locations.
Aspect 14 is the apparatus of any of aspects 1-12, where each OFDM symbol of a set of OFDM symbols associated with the PUCCH transmission is associated with a respective quantity of REs configured by the PUCCH configuration.
Aspect 15 is the apparatus of any of aspects 1-14, where the at least one processor is further configured to: transmit, to the network entity, a capability indication that indicates a support of a PUCCH format where the PUCCH transmission occupies less than one full RB per OFDM symbol.
Aspect 16 is the apparatus of aspect 15, where the PUCCH format is applicable based on a UCI type associated with the PUCCH transmission, a UCI payload size associated with the PUCCH transmission, or the quantity of OFDM symbols.
Aspect 17 is an apparatus for wireless communication at a network entity, including: at least one memory; and at least one processor coupled to the at least one memory, and based at least in part on information stored in the at least one memory, the at least one processor is configured to: transmit, for a UE, a PUCCH configuration that configures a quantity of OFDM symbols for a PUCCH transmission; and receive, from the UE based on the quantity of OFDM symbols, the PUCCH transmission, where the PUCCH transmission occupies less than one full RB per OFDM symbol.
Aspect 18 is the apparatus of aspect 17, where the PUCCH configuration further configures a quantity of a set of REs per a PUCCH resource associated with the PUCCH transmission or a set of locations of the set of REs.
Aspect 19 is the apparatus of aspect 18, where a UCI payload associated with the PUCCH transmission has a payload size smaller than a maximum payload size, or where the maximum payload size is based on the quantity of OFDM symbols and the quantity of the set of REs, or based on a RRC configuration.
Aspect 20 is the apparatus of aspect 19, where the UCI payload is mapped to a sequence, where the sequence is based on a DFT matrix that has a size equal to the quantity of OFDM symbols.
Aspect 21 is the apparatus of aspect 19, where the UCI payload is mapped to a sequence, where the sequence is based on a cyclic shift that has a cyclic shift value smaller than a maximum cyclic shift value, and where the maximum cyclic shift value is based on the quantity of the set of REs.
Aspect 22 is the apparatus of aspect 19, where the UCI payload is mapped to a sequence, where the sequence is based on a DFT matrix that has a size equal to the quantity of OFDM symbols, and where the sequence is further based on a cyclic shift that has a cyclic shift value smaller than a maximum cyclic shift value, and where the maximum cyclic shift value is based on the quantity of the set of REs.
Aspect 23 is the apparatus of any of aspects 19-22, where a RE offset associated with the UCI payload is based on the UCI payload.
Aspect 24 is the apparatus of aspect 23, where the quantity of the set of REs is based on the UCI payload, and where the RE offset is based on the UCI payload.
Aspect 25 is the apparatus of aspect 24, where the UCI payload is acknowledgment (ACK), where the quantity of the set of REs is based on a first quantity associated with the ACK, and where the RE offset is based on a first offset associated with the ACK.
Aspect 26 is the apparatus of aspect 24, where the UCI payload is NACK, where the quantity of the set of REs is based on a first quantity associated with the NACK, and where the RE offset is based on a first offset associated with the NACK.
Aspect 27 is the apparatus of any of aspects 19-26, where the UCI payload is mapped to a sequence, and where the sequence is jointly mapped over multiple slots associated with the PUCCH transmission.
Aspect 28 is the apparatus of any of aspects 19-26, where the UCI payload is mapped to a sequence, and where the sequence is divided into multiple groups in a time domain and separately mapped to each group of the multiple groups.
Aspect 29 is the apparatus of any of aspects 17-28, where each OFDM symbol of a set of OFDM symbols associated with the PUCCH transmission is associated with a respective set of REs with a respective set of locations.
Aspect 30 is the apparatus of any of aspects 17-28, where each OFDM symbol of a set of OFDM symbols associated with the PUCCH transmission is associated with a respective quantity of REs configured by the PUCCH configuration.
Aspect 31 is the apparatus of any of aspects 1-30, where the at least one processor is further configured to: transmit, to the network entity, a capability indication that indicates a support of a PUCCH format where the PUCCH transmission occupies less than one full RB per OFDM symbol.
Aspect 32 is the apparatus of aspect 31, where the PUCCH format is applicable based on a UCI type associated with the PUCCH transmission, a UCI payload size associated with the PUCCH transmission, or the quantity of OFDM symbols.
Aspect 33 is a method of wireless communication for implementing any of aspects 1 to 16.
Aspect 34 is a computer-readable medium (e.g., a non-transitory computer-readable medium) storing computer executable code, the code when executed by at least one processor causes the at least one processor to implement any of aspects 1 to 16.
Aspect 35 is an apparatus comprising means for implementing any of aspects 1 to 16.
Aspect 36 is a method of wireless communication for implementing any of aspects 17 to 32.
Aspect 37 is a computer-readable medium (e.g., a non-transitory computer-readable medium) storing computer executable code, the code when executed by at least one processor causes the at least one processor to implement any of aspects 17 to 32.
Aspect 38 is an apparatus comprising means for implementing any of aspects 17 to 32.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
receive, from a network entity, a physical uplink control channel (PUCCH) configuration that configures a quantity of orthogonal frequency-division multiplexing (OFDM) symbols for a PUCCH transmission; and
transmit, to the network entity based on the quantity of OFDM symbols, the PUCCH transmission, wherein the PUCCH transmission occupies less than one full resource block (RB) per OFDM symbol.

2. The apparatus of claim 1, wherein the PUCCH configuration further configures a quantity of a set of resource elements (REs) per a PUCCH resource associated with the PUCCH transmission or a set of locations of the set of REs.

3. The apparatus of claim 2, wherein a uplink control information (UCI) payload associated with the PUCCH transmission has a payload size smaller than a maximum payload size, or wherein the maximum payload size is based on the quantity of OFDM symbols and the quantity of the set of REs, or based on a radio resource control (RRC) configuration.

4. The apparatus of claim 3, wherein the UCI payload is mapped to a sequence, wherein the sequence is based on a discrete Fourier transform (DFT) matrix that has a size equal to the quantity of OFDM symbols.

5. The apparatus of claim 3, wherein the UCI payload is mapped to a sequence, wherein the sequence is based on a cyclic shift that has a cyclic shift value smaller than a maximum cyclic shift value, and wherein the maximum cyclic shift value is based on the quantity of the set of REs.

6. The apparatus of claim 3, wherein the UCI payload is mapped to a sequence, wherein the sequence is based on a discrete Fourier transform (DFT) matrix that has a size equal to the quantity of OFDM symbols, and wherein the sequence is further based on a cyclic shift that has a cyclic shift value smaller than a maximum cyclic shift value, and wherein the maximum cyclic shift value is based on the quantity of the set of REs.

7. The apparatus of claim 3, wherein an RE offset associated with the UCI payload is based on the UCI payload.

8. The apparatus of claim 7, wherein the quantity of the set of REs is based on the UCI payload, and wherein the RE offset is based on the UCI payload.

9. The apparatus of claim 8, wherein the UCI payload is acknowledgment (ACK), wherein the quantity of the set of REs is based on a first quantity associated with the ACK, and wherein the RE offset is based on a first offset associated with the ACK.

10. The apparatus of claim 8, wherein the UCI payload is negative acknowledgment (NACK), wherein the quantity of the set of REs is based on a first quantity associated with the NACK, and wherein the RE offset is based on a first offset associated with the NACK.

11. The apparatus of claim 3, wherein the UCI payload is mapped to a sequence, and wherein the sequence is jointly mapped over multiple slots associated with the PUCCH transmission.

12. The apparatus of claim 3, wherein the UCI payload is mapped to a sequence, and wherein the sequence is divided into multiple groups in a time domain and separately mapped to each group of the multiple groups.

13. The apparatus of claim 1, wherein each OFDM symbol of a set of OFDM symbols associated with the PUCCH transmission is associated with a respective set of REs with a respective set of locations.

14. The apparatus of claim 1, wherein each OFDM symbol of a set of OFDM symbols associated with the PUCCH transmission is associated with a respective quantity of REs configured by the PUCCH configuration.

15. The apparatus of claim 1, wherein the at least one processor is further configured to:
transmit, to the network entity, a capability indication that indicates a support of a PUCCH format where the PUCCH transmission occupies less than one full RB per OFDM symbol.

16. The apparatus of claim 15, wherein the PUCCH format is applicable based on a uplink control information (UCI) type associated with the PUCCH transmission, a UCI payload size associated with the PUCCH transmission, or the quantity of OFDM symbols.

17. An apparatus for wireless communication at a network entity, comprising:
at least one memory; and
at least one processor coupled to the at least one memory, and based at least in part on information stored in the at least one memory, the at least one processor is configured to:
transmit, for a user equipment (UE), a physical uplink control channel (PUCCH) configuration that configures a quantity of orthogonal frequency-division multiplexing (OFDM) symbols for a PUCCH transmission; and
receive, from the UE based on the quantity of OFDM symbols, the PUCCH transmission, wherein the PUCCH transmission occupies less than one full resource block (RB) per OFDM symbol.

18. The apparatus of claim 17, wherein the PUCCH configuration further configures a quantity of a set of resource elements (REs) per a PUCCH resource associated with the PUCCH transmission or a set of locations of the set of REs.

19. The apparatus of claim 18, wherein a uplink control information (UCI) payload associated with the PUCCH transmission has a payload size smaller than a maximum payload size, or wherein the maximum payload size is based on the quantity of OFDM symbols and the quantity of the set of REs, or based on a radio resource control (RRC) configuration.

20. A method for wireless communication performed by a user equipment (UE), comprising:
receiving, from a network entity, a physical uplink control channel (PUCCH) configuration that configures a quantity of orthogonal frequency-division multiplexing (OFDM) symbols for a PUCCH transmission; and
transmitting, to the network entity based on the quantity of OFDM symbols, the PUCCH transmission, wherein the PUCCH transmission occupies less than one full resource block (RB) per OFDM symbol.
